(19) United States
(12) Patent Application Publication
(10) Pub. No.: US 2003/0106058 A1
(43) Pub. Date: Jun. 5, 2003

(54) Media recommender which presents the user with rationale for the recommendation

(75) Inventors: John D. Zimmerman, Ossining, NY (US); Kaushai Kurapati, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/015,709

(22) Filed: Nov. 30, 2001

(51) Int. Cl. H04N 7/16; H04H 9/00; H04N 7/025; H04N 7/10; G06F 3/00; H04N 5/445; G06F 13/00

(52) U.S. Cl. 725/46; 725/9; 725/34; 725/35

(57) ABSTRACT

The present invention is an improvement over previous media recommender systems in that it provides, among other things, not only a recommendation but also an explanation to the user as to why that recommendation is being made.

### BACKGROUND OF THE INVENTION

1. Field of the Invention

The present invention relates a method and apparatus for recommending media programming to a consumer and more particularly, to a method and apparatus for providing the consumer with one or more specific reasons why the recommendation was made.

2. Description of Related Art

As the number of channels available to television viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, the ability to effectively identify desirable television programs using such printed guides has become impractical.

More recently, television program guides have become available in an electronic format, often referred to as electronic program guides (EPGs). Like printed television program guides, EPGs contain grids listing the available television programs by time and date, channel and title. An EPG, however, allows television viewers to sort or search the available television programs in accordance with personalized preferences. In addition, EPGs allow for on-screen presentation of the available television programs.

While EPGs allow viewers to identity desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs or sports programming. These viewer preferences can then be applied to the EPG to obtain a set of recommended programs that may be of interest to a particular viewer.

A number of tools have been proposed or suggested for recommending television programming. The Tivo™ system, for example, commercially available from Tivo, Inc., of Sunnyvale, Calif., allows viewers to rate shows using a “Thumbs Up and Thumbs Down” feature and thereby indicate programs that the viewer likes and dislikes, respectively. Thereafter, the Tivo receiver matches the recorded viewer preferences with received program data, such as an EPG, to make recommendations tailored to each device.

Further, prior art systems do not require specific user input to make recommendation decisions. An example of such a system, which employs decision trees, is described in a patent application, PCT WO 01/45408 (Gutta). Gutta uses inductive principles to identify a set of recommended programs that may be of interest to a particular viewer, based on the past viewing history of a user. Gutta monitors a user's viewing history and analyzes the shows that are actually watched by a user (positive examples) and the shows that are not watched by the user (negative examples). For each positive and negative program example (i.e., programs watched and not watched), a number of program attributes are classified in the user profile, such as the time, date, duration, channel, rating, title and genre of a given program. These various attributes are used to generate a decision tree. The decision tree is applied to an electronic program guide to make program recommendations. The program recommendations may be, for example, a set of recommended programs that may be of interest to a particular viewer.

Thus, such tools for recommending television programming provide selections of programs that a viewer might like, based on the viewer's past viewing history as well as a profile containing viewer preferences. Frequently though, a user is presented with several recommendations, perhaps for programs that conflict in time. He is then faced with a decision as to which of the recommended programs he is to select. This decision is made even more difficult should the recommended programs be new programs and it is not clear why the recommendations were made.

Recommender systems are also well known in the prior art that are applicable for various other media, such as music or books. The above discussion, which was directed primarily to television programming, is also relevant to these systems.

A need exists in the prior art to offer the user at least a partial explanation for the recommendation being made. At a minimum, providing the rationale establishes credibility to the resulting decision. That is, the system would tend to build trust in the recommendations it is making and allow for some forgiveness if the recommendation turns out to not match the user's tastes. It also permits the user, to consider the stated criteria used in the recommendation to aid him in choosing between alternative recommendations (which may conflict in time). Further, providing such rationale may be of significant value in a recommendation involving a new program or media selection with which the user is unfamiliar. Thus, for example, a writer/director combination for which the user's viewing history has indicated a past preference is present in a recommended new movie or television program. Providing the user with this fact as a rationale for the recommendation can be of significant value to the user, as he may not make such an association on his own.

### SUMMARY OF THE INVENTION

It is an object of the present invention to provide a method and apparatus for recommending media programming to the user and offering the user an explanation for the recommendation.

A more complete understanding of the present invention, as well as further features and advantages of the present invention, will be obtained by reference to the following detailed description and drawings.

### BRIEF DESCRIPTION OF THE DRAWINGS

FIG. 1 illustrates a prior art television programming recommender;

FIG. 2 illustrates a hierarchical decision tree used in the prior art to evaluate various attributes of television programs in determining a recommendation;

FIG. 3 illustrates a television programming recommender in accordance with one embodiment of the present invention, and;

FIG. 4 is a flow chart describing an exemplary process embodying principles of the present invention.

### DETAILED DESCRIPTION

The disclosed media recommender utilizes any of the various known methods in the prior art which evaluate various attributes of the consumer's past media selections to derive a recommendation. In this application the term media, media selections and media programs is intended to include, but not be limited to, television programming, movies, music, and various print media, to include books. A typical recommender system learns by observing the user's selection habits over time and generalizing these selection habits to build a user profile.

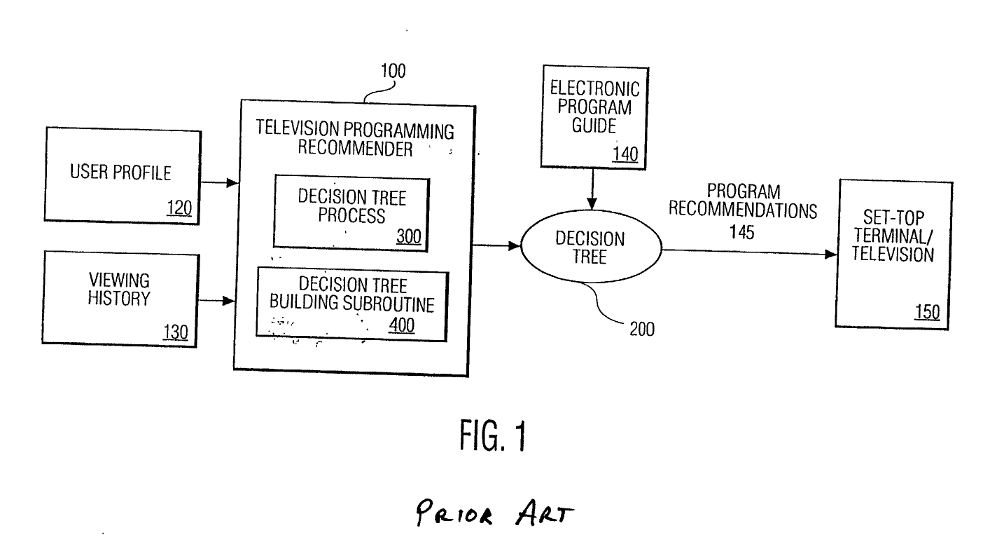

One such system, applicable to television, is illustrated in FIG. 1 and described in detail in patent application PCT WO 01/45408 (Gutta). As described in that application, the recommender processes a user profile 120, if available, and a user's viewing history 130 to generate a decision tree 200. This decision tree 200 may then be applied to an electronic program guide 140 to make program recommendations that may be of interest to a viewer.

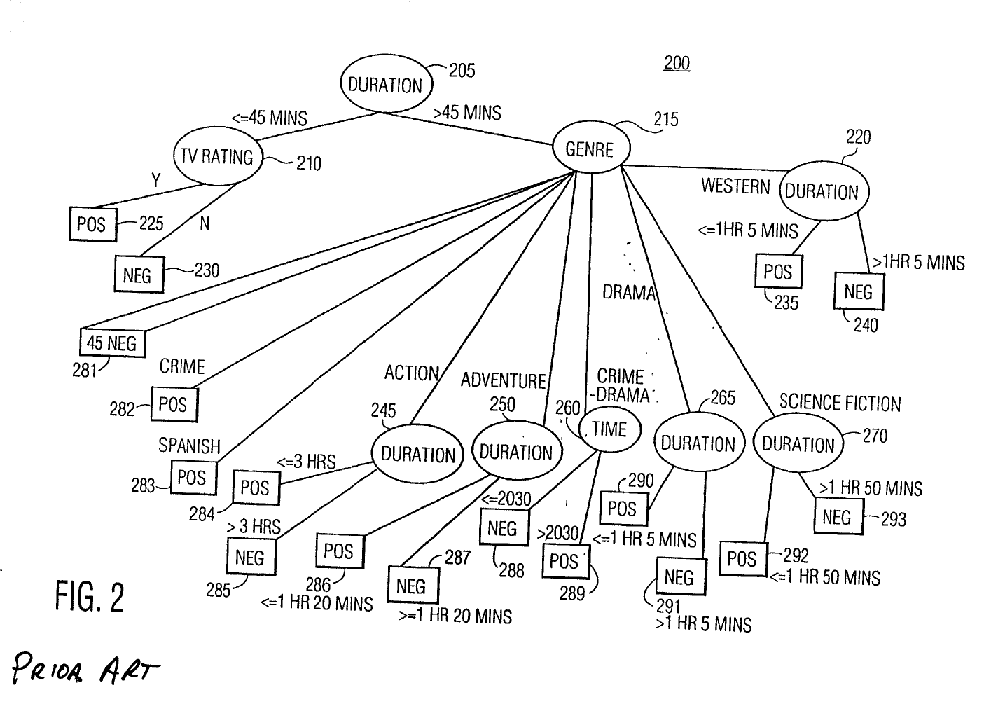

FIG. 2 provides further detail of the Gutta application. In particular, it illustrates a hierarchical decision tree that positions various attributes of television programs.

These attributes include specifics of the programs watched to include time, date, duration, channel, rating, title and genre.

In one embodiment of the present invention, a system operates chiefly independent of such a prior art recommender. In this embodiment the system collects a viewing history of programs watched by the user. It also keeps track of the descriptions of these shows as for example, descriptions found in databases such as Tribune Media. It then constructs a user profile in which data is accumulated as to the various program attributes, e.g., actor, director, writer, producer, etc. When a new show is recommended by a recommender system, the present invention will search to find a correlation between attributes of the recommended show and attributes of shows in the viewer's history. Further, in addition to the prior art attributes noted in prior art such as Gutta, the present invention also considers names of actors, writers, producers, directors, special guests, etc. that appear often in the user's viewing history. If it finds a match it will rationalize the recommended new show based on a link to either the most recent occurrence or the most often occurrence. That is, it will augment a simple recommendation of a show with a rationale for why that recommendation is being made.

Thus, for example, the prior art recommender determines Top Gun as a recommended program that is new or previously unwatched by the user. The present invention searches the user's profile and discovers that the actor Tom Cruise appears often in previously watched programs. It then looks back over the viewing history and learns that the last movie the user saw that starred Tom Cruise was Rainman. The system, in making a recommendation based upon a most recent watched show, would enhance the recommendation of the movie Top Gun with a reminder that the user had previously seen Tom Cruise, the star of Top Gun, in the movie Rainman.

By way of another example, the prior art recommender determines the TV show Charmed to be a recommended program. The present invention searches the user's profile and discovers that the producer Aaron Spelling appears often. It looks back over the viewing history and learns that the most watched show produced by Aaron Spelling is Beverly Hills 90210. The system then augments the recommendation of Charmed with a reminder to the user that this show is produced by the same person who produced Beverly Hills 90210.

The above examples of reporting criteria, “most recent watched” (Time) or “most watched” (Volume) are selectable by the user. That is, either one or both of these criteria could be chosen as the basis of the invention's output. In such a system, default criteria would be automatically set with the viewer having an option of modifying them. In one embodiment a “slider” icon can be used to permit the user to set the relative weightings. That is, a linear scale is presented to the user with Time displayed at one end of the scale and Volume at the other. By simply moving the slider along this scale, the user can select the relative weighting of these criteria. Thus for example, position the slide at the Time end of the scale would result in 100% usage of “most recent watched” history and 0% consideration of “most watched” data.

In another embodiment, the system gives stronger weightings to more recent viewing history. One means for doing such is to periodically reduce the importance of older history records as they age. For example, every month a 10% reduction would be imposed. In this embodiment the actual period and the percentage of decay would be parameters that are assigned default values but which are readily changeable by a user interface.

In another embodiment of the invention a user may input into the system other criteria to be used in the rationale for a recommendation Accordingly the user could thereby give a preference or weighting to various combinations of viewing history attributes. An example of the value of such combinations might be where the user perceives a synergistic relationship between a particular actor, e.g. Jeri Ryan, and a particular producer, e.g. David Kelly. That is, the user may have a slight preference for programs having Jeri Ryan as an actress and a weak preference for producer Kelly, but yet he realizes that when these two artists are combined, he has a significant preference for the resulting program Moreover, the system itself looks for the existence of such combinations present in viewing history as the user may not initially appreciate their value or even their existence. Whether entered by the user or determined by the system, the present invention has the capability of reporting to the user when such relationships are present in a recommended program.

In an alternative embodiment, the invention is incorporated into the recommender system itself, rather than acting independently. For example, in such a system the user profile 120 and viewing history 130 of a prior art system would be augmented to include the data necessary for the current system to determine and display the rationale for a recommendation. Such a system may make the recommendation decision using prior art techniques and then display the rationale for the decision using the criteria discussed above. In addition, the system could permit the user to select preferences (such as a combination of actor and producer) that would be used in the determination of the recommendation as well as in the reporting to the user of the rationale for the recommendation.

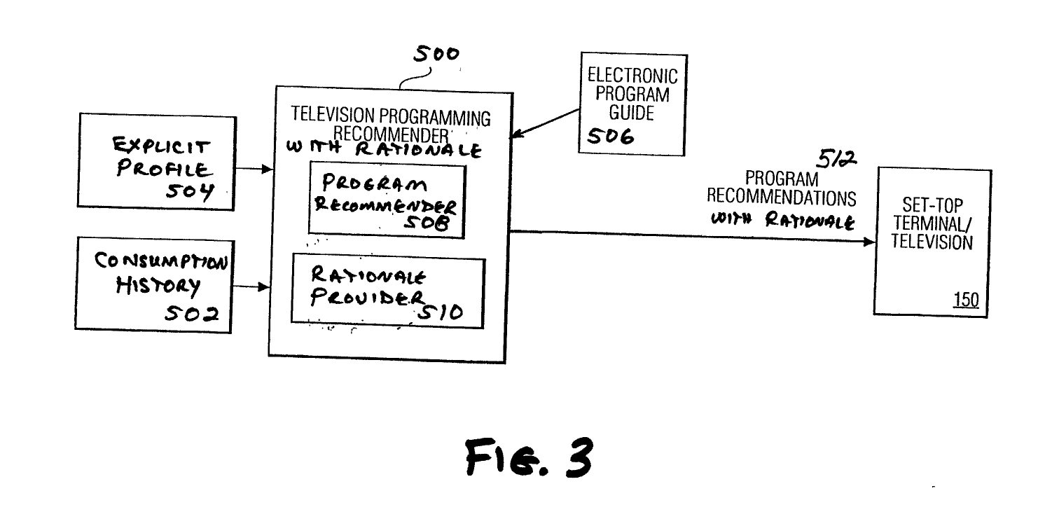

FIG. 3 is a block diagram illustrated a television recommender in accordance with this embodiment of the invention. Such a system can be implemented in a variety of combinations of software and hardware devices. By way of example, the television programming recommender with rationale provider 500 would comprise a central processing unit (CPU) with one or more memory devices. Explicit profile 504 and consumption history 502 would be stored in a read/write nonvolatile memory device such as a disk. Further by way of example, the electronic program guide 506 would be obtained via an Internet connection and stored on disk where it would be updated periodically.

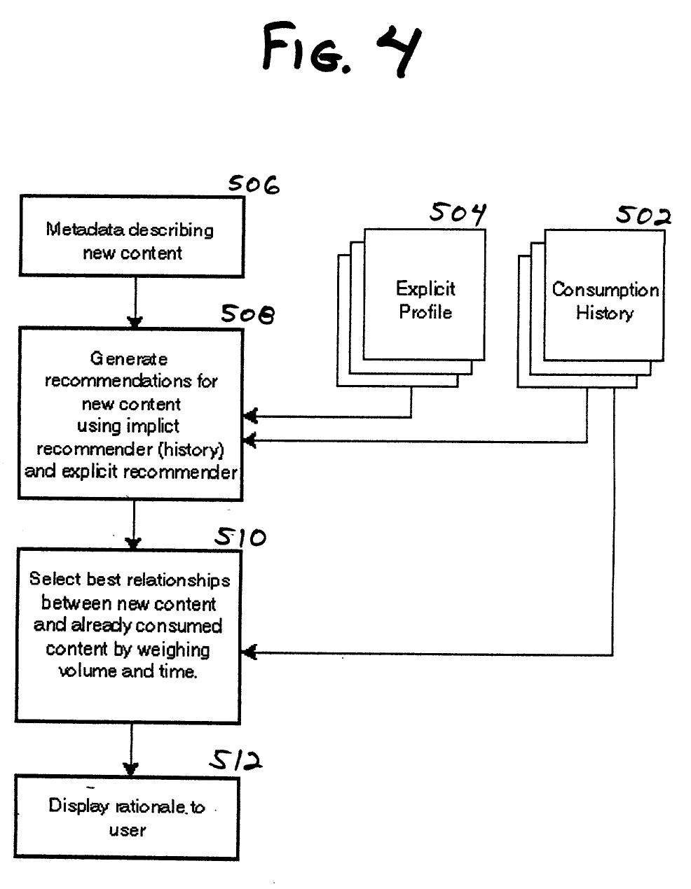

FIG. 4 is a flow chart which illustrates the process employed by this embodiment of the invention. The system collects a viewing history of programs watched by the user. It also keeps track of the descriptions of these shows as for example, descriptions found in databases such as Tribune Media. It then constructs a user's Consumption History 502 in which data is accumulated as to the various program attributes, e.g., actor, director, writer, producer, etc. The system also permits construction of a user Explicit Profile 504 in which the user can specifically note any preferences he may have for specific attributes or combinations thereof.

Data relating to new shows 506 are input and evaluated based on these attributes. As in a conventional prior art recommender system, a scoring algorithm is employed which yields one or more recommendations 508. When a new show is recommended, the present invention will search to find a correlation between attributes of the recommended show and attributes of shows in the consumption history or explicit profile. In particular, the present invention will attempt to select one or more best relationships 510 as a rationale for the decision. This rationale is then presented 512 to the user.

FIGS. 3 and 4 relate to an embodiment of the invention wherein the Rationale Provider 510 and the Program Recommender 508 are both contained in one physical unit, the Television Programming Recommender with Rationale 500. The principles illustrated by these figures are applicable to other embodiments of the invention, in particular, those embodiments described above in which the rationale provider system is chiefly independent of a conventional recommender.

In an additional embodiment of the invention the rationale that is selected for presentation is one that provides an understandable justification to the user—one he can readily identify with Further, this rationale is not presented in a clinical manner, but rather in a conversational tone, much like a knowledgeable friend would make. As an example, in recommended a new program, Dracula 2000, the system tells the user that Dracula 2000 stars Jeri Ryan who frequently appears in Star Trek Voyager (the latter show being one for which the user has demonstrated a preference).

In a preferred embodiment the system attempts to identify and display human to human relationships of the creators of the show's content. Thus, the system looks to identify user preferences relating not only to specific writers, producers, directors or actors but moreover seeks user preferences for combinations of those artists. Such person to person combinations (e.g., between actors and directors, writers and producers, etc.) may yield a synergistic product that the user may appreciate.

While the above embodiments have addressed the area of television programming, the invention is not limited to this media. Additional embodiments of the invention include analysis and recommendations for any media for which electronic data is available. For example, a user history and profile may accumulate on a user's reading habits. Book purchases over the Internet, monitoring of library checkouts, and a user's manual entry of data are examples of sources of information. Examples of criteria to be evaluated would include author, publisher, keywords or phrases appearing in the text or a synopsis of the book, or even the name of a character.

The present invention is also applicable in the field of music where the evaluation criteria may include vocalists, musicians, writers, producers, band, etc. A user's consumption history could be obtained, inter alia, from electronic records of purchases or downloads of music.

As in the case of television programs described above, in addressing other media types the invention would permit the user to program the system to place added emphasis on various attributes or combinations thereof And as before, the system would look for these combinations as well. Thus for example, where a potential synergistic relationship exists (e.g. a particular producer performing with a particular band), the system would make a recommendation on that basis and provide an output to the user noting this as a rationale for the recommendation.

In yet another embodiment of the invention, a single system would perform its recommendation with rationale function in more than one media domain. Moreover, it would seek rationale across these domains. For example, it may recommend a television show in which a liked musician may be appearing or which may be written by a book author the user has displayed a preference for. Even further, it may recommend an upcoming new television show and provide the rationale that it has a writer-producer combination that the user has displayed a preference for in movies. Such human to human relationships of media's content creators may very well be a significant (yet previously unperceived) reason a user may like a particular media program.

The embodiments of the invention described below are applicable to the present invention whether or not it is incorporated into a prior art recommender or functioning independently of it. One such embodiment is that the invention be a local set top box at the television. Alternatively, the invention may be present in one or more central systems of the user's household, such as a home media server.

Alternative embodiments have the invention located away from the user's household. For example, it may be located at the facility of a cable provider where the system of the present invention is provided as an additional service to the user's household. In addition, use of Internet technology may permit the system to reside at a location even farther removed from the user.

Such central data collection locations raise privacy issues to potential users. Security safeguard measures for such central data sites are well known. The present invention contemplates use of various alternative self-identifiers in accessing the system. By way of example, these may include the use of passwords, biometrics (e.g., fingerprint or eye scanning), or radio frequency tags. Use of such self-identifiers has several advantages. It permits the use of a central system and thereby enables the system to operate when the user is away from home. Thus, a user in a hotel would be able to obtain recommendations and rationale for them when he is faced with unfamiliar channels and/or perhaps, limited programs in his native language. In addition, use of a self-identifier, especially one that is automated and not requiring direct user input, has advantages when the system is located in the user's home. For example, it permits the system to accumulate a database that accurately reflects the specific user. It also may restrict access to that database by other members of the household.

It is to be understood that the embodiments and variations shown and described herein are merely illustrative of the principles of this invention and that various modifications may be implemented by those skilled in the art without departing from the scope and spirit of the invention In particular, it is contemplated that the invention may include any features of current well-known media recommender systems.

1. An apparatus for obtaining for a user a recommendation for a media program and one or more rationale for that recommendation for a media program, said program having attributes, said apparatus comprising:
a means for obtaining a consumption history of past media programs selected by said user;
a means for generating an explicit profile for said user comprises collecting data of program attributes for said past media program selections;
a means for determining both a recommendation and a rationale for said recommendation by analyzing said data; and,
a means for communicating said recommendation and said rationale to the user.

2. The apparatus of claim 1 wherein the means for generating an explicit profile further comprises obtaining information provided by said user.

3. The apparatus of claim 1 wherein the means for determining comprises a means for obtaining attributes of new programs.

4. The apparatus of claim 3 wherein the means for determining further comprises a means of scoring correlations of said programs attributes of past media program selections with attributes of said new programs.

5. The apparatus of claim 4 wherein the means for scoring comprises utilizing a user selectable weighting of program attributes of most recent past media program selections and program attributes of most frequently occurring past media program selections.

6. The apparatus of claim 1 wherein the rationale for said recommendation is a justification that is readily understood to the user.

7. The apparatus of claim 1 wherein the communication for said rationale to the user is performed in a conversational tone.

8. The apparatus of claim 1 wherein the means for determining a rationale for said recommendation comprises identifying program attributes relating to human to human relationships of the creators of the programs' content.

9. The apparatus of claim 8 wherein the human to human relationships comprises collaborative efforts of actors, directors, writers, producers, musical bands, singers, musicians, or other creators of the programs' content.

10. The apparatus of claim 1 wherein the means for determining a rationale for said recommendation comprises identifying program attributes relating to one or more characters contained in the programs' content.

11. The apparatus of claim 1 wherein past media program comprises one or more of the following media types: television programs, movies, music, and print media.

12. A system for obtaining for a user a recommendation for a media program and one or more rationale for that recommendation for a media program, said program having attributes, said system comprising:
a memory for storing computer readable code; and a processor operatively coupled to said memory, said processor configured to:
obtain a consumption history of past media programs selected by said user;
generate an explicit profile for said user wherein data of program attributes is accumulated for said past media program selections;
determine both a recommendation and a rationale for said recommendation by analyzing said data; and,
communicate said recommendation and said rationale to the user.

13. A system for obtaining for a user a rationale for a media recommender recommendation for a media program, said program having attributes, said system comprising:
a memory for storing computer readable code; and a processor operatively couple to said memory, said processor configured to:
obtain a consumption history of past media programs selected by said user;
generate an explicit profile for said user wherein data of program attributes is accumulated for said past media program selections;
review said recommendation provided by a media recommender and determine a rationale for said recommendation by analyzing said data; and,
communicate said rationale to the user.

14. A method for obtaining for a user a recommendation for a media program and one or more rationale for that recommendation for a media program, said program having attributes, said method comprising the steps of:
obtaining a consumption history of past media programs selected by said user;
generating an explicit profile for said user comprises collecting data of program attributes for said past media program selections;
determining both a recommendation and a rationale for said recommendation by analyzing said data; and,
communicating said recommendation and said rationale to the user.

15. The method of claim 14 wherein the step of generating an explicit profile further comprises obtaining information provided by said user.

16. The method of claim 14 wherein the step of determining comprises a step of obtaining attributes of new programs.

17. The method of claim 16 wherein the step of determining further comprises a step of scoring correlations of said programs attributes of past media program selections with attributes of said new programs.

18. The method of claim 17 wherein the step of scoring comprises utilizing a user selectable weighting of program attributes of most recent past media program selections and program attributes of most frequently occurring past media program selections.

19. The method of claim 14 wherein the rationale for said recommendation is a justification that is readily understood to the user.

20. The method of claim 14 wherein the step of communicating said rationale to the user is performed in a conversational tone.

21. The method of claim 14 wherein the step of determining a rationale for said recommendation further comprises identifying program attributes relating to human to human relationships of the creators of the programs' content.
